(19) United States
(12) Patent Application Publication
(10) Pub. No.: US 2003/0053054 A1
(43) Pub. Date: Mar. 20, 2003

(54) Methods, apparatus, computer program products, and systems for ferrule alignment and fabrication of optical signal controllers

(76) Inventors: Bulang Li, Fremont, CA (US); Navrit Singh, Fremont, CA (US)

Correspondence Address: LARRY WILLIAMS, 122 CALISTOGA ROAD, PMB-301, SANTA ROSA, CA, 95409-3702, US

(21) Appl. No.: 10/179,461

(22) Filed: Jun. 24, 2002

Related U.S. Application Data
(60) Provisional application No. 60/300,536, filed on Jun. 22, 2001.
(60) Provisional application No. 60/300,517, filed on Jun. 22, 2001.

(51) Int. Cl. G01B 11/00

(52) U.S. Cl. 356/399

(57) ABSTRACT

Methods and apparatus are provided for manufacturing optical signal controllers such as optical switches. The methods and apparatus can be used for aligning optical elements such as output ferrules for the optical signal controller. The methods and apparatus may allow substantially automated alignment of optical components in the optical signal controller.

### CROSS-REFERENCE

The present application claims benefit of U.S. Provisional Patent Application No. 60/300,536, filed on Jun. 22, 2001 and U.S. Provisional Patent Application No. 60/300,517, filed on Jun. 22, 2001. The present application is related to U.S. Provisional Patent Application No.60/300,536, filed on Jun. 22, 2001, U.S. Provisional Patent Application No. 60/300,517, filed on Jun, 22, 2001, and U.S. Provisional Patent Application No. 60/256,059, filed on Dec. 15, 2000. All of these applications are incorporated herein, in their entirety, by this reference.

### BACKGROUND

This invention relates to improved methods, apparatus, and systems for output ferrule alignment for fabricating optical signal controllers such as optical switches, variable optical attenuators, and optoelectronic switches.

Optical switches and interconnects are relatively new devices used primarily in the communications industry. They are primarily used for optical networks and for optical network testing and measurements. This technology is currently in its infancy, and new applications are being developed rapidly.

U.S. Provisional Patent Application No. 60/256,059, filed on Dec. 15, 2000, describes an optical switch that includes high speed, high precision motors such as voice coil motors to carry out optical switching for applications such as optical signal based communication systems. This configuration is expected to have a switch time delay per channel that is significantly shorter than that for standard optical switch technology. Some embodiments of the invention described in Application No. 60/256,059 are expected to have switch time delays that may be about a factor of 10 (or more) shorter than that for the standard optical switch technology. U.S. Provisional Patent Application No. 60/256,059, filed on Dec. 15, 2000 is incorporated herein, in its entirety, by this reference.

Optical switches such as those described in Application No. 60/256,059 require alignment of the optical components involved in the switching. Specifically, the aligning of optical components such as optical fiber ferrules for output channels is a critical part of the optical switch manufacturing process. The standard methods for optical alignment are time-consuming and difficult because of the level of precision that is acquired. Indeed, the alignment process can significantly increase the cost of manufacturing optical signal controllers. In addition, new switch technologies such as those described in Application No. 60/256,059 that use rotary switching operations make the standard alignment process even more problematic.

There is a need for reliable and efficient methods and apparatus for optically aligning optical fiber ferrules in optical signal controllers such as optical switches. Furthermore, there is a need for complete systems capable of allowing rapid alignment of rotary motion based optical signal controllers such as optical switches. In addition, there is a need for optical signal controllers that have greater reliability and increased capabilities for long-term reliable operation.

### SUMMARY

This invention is related to optical and optoelectronic systems that use optical signal controllers such as those used for communication, information processing, and information transfer. More specifically, the invention is related to methods, apparatus, systems, and computer program products for optical component alignment in optical signal controllers such as optical switches, methods of manufacturing optical signal controllers, a station for manufacturing optical signal controllers, and optical signal controllers. It is to be understood that optical signal controllers may also include a power monitor, a fiber collimator, an optical isolator, and an optical circulator.

An aspect of the invention includes methods of aligning optical fiber ferrules used in output channels of optical signal controllers such as aligning ferrules in optical switches. Another aspect of the present invention includes apparatus for aligning optical elements such as optical fiber ferrules. Another aspect of the present invention includes software and computer program products for aligning optical elements such as optical fiber ferrules. Still, another aspect of the present invention includes optical signal controllers having optical elements that have been aligned using methods according to the present invention.

It is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out aspects of the present invention. It is important, therefore, that the claims be regarded as including such equivalent constructions insofar as they do not depart from the spirit and scope of the present invention.

The above and still further features and advantages of the present invention will become apparent upon consideration of the following detailed descriptions of specific embodiments thereof, especially when taken in conjunction with the accompanying drawings.

### DESCRIPTION OF THE DRAWINGS

FIG. 1 is a diagram of an embodiment of the present invention.

FIG. 2 is a diagram of components illustrated in the embodiment of the present invention shown in FIG. 1.

FIG. 3 is a diagram of an embodiment of the present invention.

FIG. 3a is a diagram of an embodiment of the present invention.

FIG. 4 is a schematic diagram of an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

This invention pertains to methods, apparatus, systems, and computer program products for optical component alignment in optical signal controllers such as alignment of optical switches, optical switch manufacturing processes, and optical switches. The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In one embodiment, the apparatus includes an optical component capable of projecting an optical signal and capable of receiving a reflected optical signal, one or more output channels having optical fiber ferrules, and a driver such as a voice coil motor. The voice coil motor is coupled to the optical component so that movement of the voice coil motor can be used to actively adjust the direction of optical signal projection from the input optical component. The ferrules are disposed so as to receive optical signals projected from the optical component; each lens is associated with an optical channel. Preferably, in completed optical signal controllers, the output channels are arranged so as to allow continuing the propagation of the optical signal or otherwise processing the optical signal.

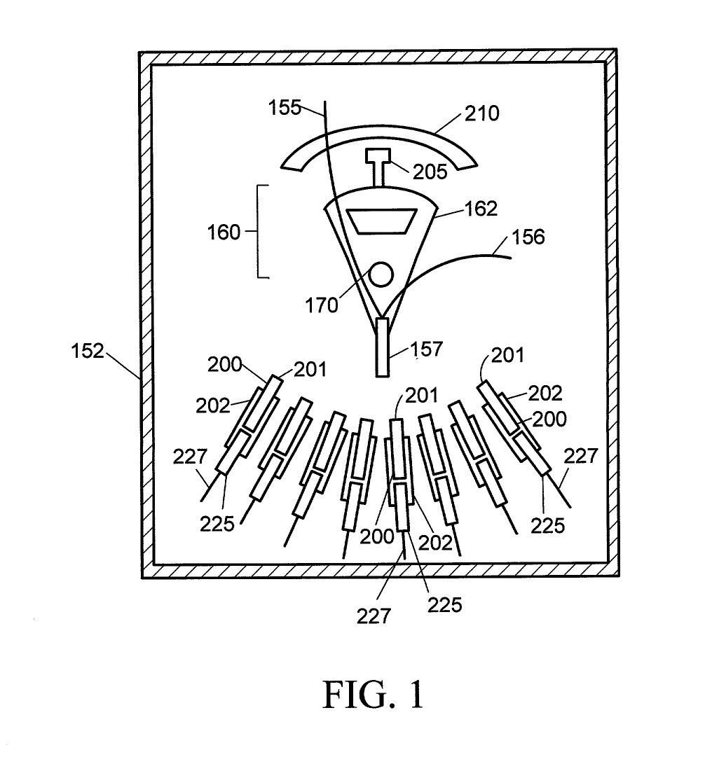

Reference is now made to FIG. 1 wherein there is shown a diagram of an optical switch wherein the optical components, specifically output optical fiber ferrules, are aligned according to an embodiment of the present invention. The optical switch includes a housing 152, an input optical fiber 155, a reflected signal optical fiber 156, collimator 157, a voice coil motor 160, a pivot bearing 170, at least one, preferably a plurality, of output gradient refractive index lens 200 corresponding to output optical signal channels, and an output optical fiber ferrule 225 associated with each of lens 200. Lens 200 includes a semi reflective face 201 having a predetermined reflectivity for an aligned incident light beam. Ferrule 225 includes an end portion of an output optical fiber 227.

The embodiment shown in FIG. 1 also includes an output channel support 202 for holding lens 200 and for holding ferrule 225. Support 202, optionally, maybe an integral part of housing 152. In other words, support 202 may be a surface of housing 152. Alternatively, support 202 may be a discrete structure connected with housing 152 so as to hold lens 200 and ferrule 225 substantially within housing 152. Preferably, support 202 is a substantially rigid structure capable of holding lens 200.

FIG. 1 shows housing 152 in cross-section; specifically, the top section of housing 152 has been removed to provide a top view of the interior of housing 152. Housing 152 substantially contains voice coil motor 160. Voice coil motor 160 includes coil 162 and permanent magnets (the permanent magnets are not shown in FIG. 1) set in a standard arrangement for a rotary motion voice coil motor similar to that commonly used in disk drives. It is to be understood that the fundamental operation of voice coil motors is a well-understood technology. As such, the details of voice coil motor technology are not repeated in this description. However, the information is readily available in the technical literature and published patents. For example, see U.S. Pat. No. 5,329,412, incorporated herein by this reference.

Voice coil motor 160 is rotatably coupled to pivot bearing 170 to allow rotary motion about pivot bearing 170. Pivot bearing 170 is supported by housing 152. Input optical fiber 155 and reflected signal fiber 156 are coupled with collimator 157 forming a dual fiber collimator. The collimator 157 is connected with voice coil motor 160 so that rotary motion of voice coil motor 160 causes collimator 157 to move so as to change the direction of optical signal propagation or optical signal reception for collimator 157. Preferably, a controller (not shown in FIG. 1) provides the control signals for voice coil motor 160. Input optical fiber 155 is arranged to project optical signals toward lens 200 and ferrule 225 so that lens 200 and ferrule 225 receives the optical signals.

In preferred embodiments, the reflective face 201 of lens 200 comprises a semi-reflective coating applied to lens 200 so as to reflect a predetermined percentage of an aligned incident light beam such as that which occurs when the lens is properly aligned with respect to optical signals from collimator 157 and optical fiber 155. Consequently, and measurements of the transmitted optical signal can be used as a control signal for optical alignment between ferrule 225 and collimator 157. In other words, embodiments of the present invention use the measurements of the transmitted power signal to provide a control signal for closed loop process control of the alignment process.

During the alignment process, input optical fiber 155 is coupled to a laser light source for providing the input optical signal. In addition, fiber 227 is connected with a detector for measuring the intensity of light received by ferrule 225 and fiber 227. The light intensity measured at fiber 227 when compared to the light directed toward ferrule 225 provides an indication of the optical alignment between ferrule 225 and collimator 157. In other words, when the light intensity measured by the detector connected with fiber 227 substantially equals the light intensity that should be received by ferrule 225, then ferrule 225 is optically aligned with collimator 157. Achieving optical alignment for ferrule 225 and collimator 157 means that the output channel is optically aligned with the input optical signal.

In a preferred embodiment of the alignment process, fiber 156 is coupled to an optical signal detector capable of measuring optical signal intensity of the reflected optical signal. The reflected optical signal from the semi reflective face 200 is directed back toward collimator 157. The collimator 157 receives the reflected signal and transmits the reflected signal to the reflected signal optical fiber 156. Measurements of the reflected signal can be used to provide a more accurate indication of the amount of light that should be received at ferrule at 225. For some embodiments of the alignment process, the reflected signal can be used to help determine the position of collimator 157.

FIG. 1 also shows, as an option, a position indicator for electronically monitoring the position of the voice coil motor. Those of ordinary skill in the art will recognize that a wide variety of hardware configurations can be used to perform as the position indicator. The embodiment shown in FIG. 1 includes a photosensor 205 connected with coil 162 of voice coil motor 160 so that photosensor 205 moves with coil 162. An array of LEDs 210 is arranged near photosensor 200 so that photosensor 205 can derive position information by detecting the LEDs in array of LEDs 210. Of course, in an alternative embodiment, a movable photodiode may be used and an array of photo detectors can be used.

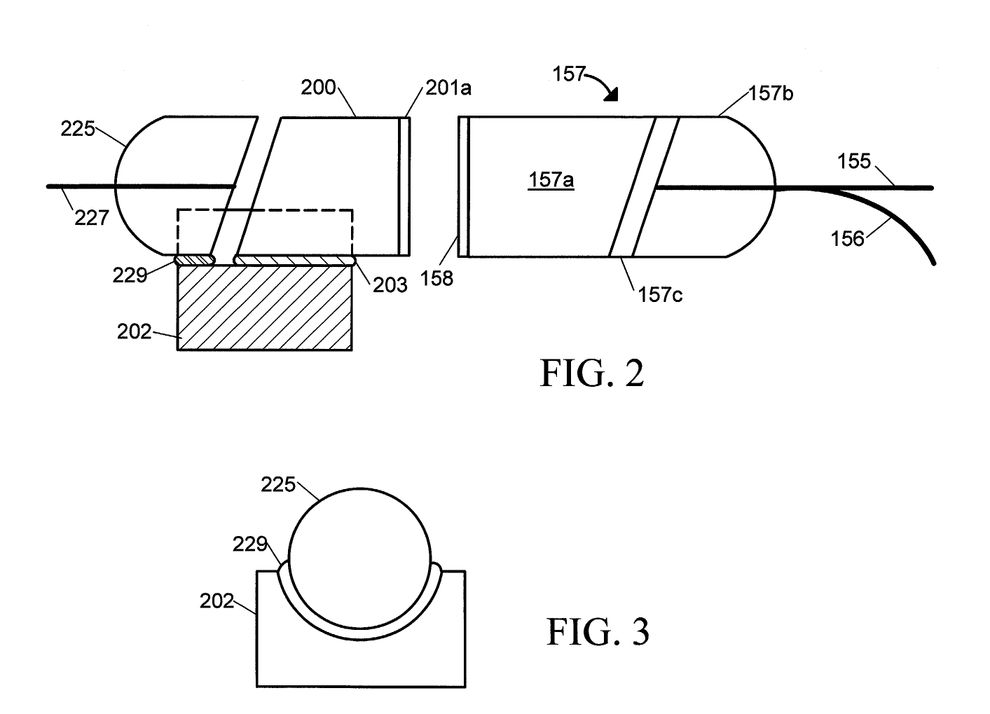

Reference is now made to FIG. 2 wherein additional details of the switch in FIG. 1 are shown. FIG. 2 shows collimator 157; collimator 157 is a dual fiber collimator as stated supra. In order to simplify the present description, FIG. 2 does not show the attachment of collimator 157 to the voice coil motor indicated in FIG. 1. FIG. 2 shows input optical fiber 155 and reflected signal optical fiber 156 are coupled to collimator 157. Collimator 157 includes a gradient refractive index lens 157a and an optical fiber ferrule 157b for holding the ends of fiber 155 and fiber 156. Ferrule 157b can hold the ends of optical fiber 155 and fiber 156 in place. In this embodiment, the ends of fiber 155 and fiber 156 substantially face the same direction. Optionally, an attaching material, such as epoxy 157c, couples lens 157a and ferrule 157b together. In preferred embodiments of the present invention, an antireflection coating 158 is applied to the output surface of collimator 157 that receives the reflected signal.

The use of collimators with optical fibers is well known to those skilled in the art; there are numerous possible configurations and the example given here for collimator 157 is not to be interpreted as a limitation for embodiments of the present invention. As an example alternative, GRIN lens 157a may be held in place by fittings and epoxy 157c may be replaced by air gaps. Preferably, antireflection coating is also applied to the angled surfaces of 157a and 157b, when epoxy 157c is replaced by an air gap to ensure an epoxy-free light path.

FIG. 2 shows lens 200 contacting semi-reflective film 201a. A gap such as an air gap lies between film 201a and film 158. The size of the air gap typically depends on the size of the fittings and amount of the signal to be reflected back to fiber 156. Typically, the air gap may be in a range of approximately 100 microns to 5 millimeters. A smaller air gap typically gives better performance. However, enough space should be allotted for movement of parts within the housing 152 without films 201a and 158 contacting each other.

FIG. 2 also shows an embodiment of how lens 200 can be bonded to housing 152. Support 202 is shown in cross-section in FIG. 2. In this embodiment, support 202 is a substantially rigid structure connected with the base of housing 152 so that optical elements attached to support 202 are held in a substantially rigid position with respect to collimator 157. Support 202 includes a recessed area in which at least a portion of lens 200 fits therein. The hidden upper edge of support 202 is shown with broken lines. The recessed area is an option and other configurations may be used that may not include a recessed area. An attaching material 203 is shown in cross-section contacting lens 200 and support 202; attaching material 203 is provided to form a substantially fixed attachment of lens 200 to support 202. Examples of suitable attaching materials are epoxy, solder, and other attaching materials typically used in the fabrication of optical devices.

FIG. 2 also shows ferrule 225 and associated fiber 227. In this embodiment, ferrule 225 is connected with support 202 in substantially the same way that lens 200 is connected with support 202. Specifically, an attaching material 229, shown in cross-section in FIG. 2, attaches ferrule 225 to the recessed area of support 202. The arrangement shown in FIG. 2 includes a gap between lens 200 and ferrule 225. It is to be understood that this arrangement is not required for all embodiments of the present invention. For some embodiments the gap may be replaced by a material such as epoxy.

Attention is now directed to films 201a and 158 and the operation of the optical configuration shown in FIG. 2. An optical signal at a first light intensity is transmitted through optical fiber 155 to lens 200. A small portion of the optical signal is reflected by semi-reflective film 201a back to optical fiber 156. Films 201a and 158 typically have a composition different from their adjacent GRIN lenses 200 and 157a, respectively. Films 201a and 158 are typically an oxide, a nitride, or a combination thereof. Some examples of the materials for films 201a and 158 include silicon nitride, titanium dioxide, tantalum nitride, other refractory metal oxides or nitrides, combinations thereof, or the like. Films 201a and 158 may have compositions that are the same or different from each other.

The amount or lack of reflection by films 201a and 158 can be adjusted by controlling the thickness of films 201a and 158. The thickness of film 158 should be selected to minimize reflection. In other words, reflection should be as close to zero as reasonably possible. The thickness of film 201a should be selected to allow a relatively small fraction of light to be reflected. Typically, the amount of reflection of the light from optical fiber 155 should be in a range of approximately 0.2 to 5.0 percent and more commonly in a range of approximately 0.5 to 1.5 percent. Ideally, the amount of reflection may be approximately 1.0 percent. By knowing the composition of the films 201a and 158, the wavelength of the light, and the amount of light, if any, to be reflected, skilled artisans may use conventional method(s) to determine the thicknesses of films 201a and 158.

The use of gradient refractive index lenses 200 and 157a is not required. Other optically transparent objects may be used. The surfaces of the other optically transparent objects near films 201a and 158 should be substantially flat. In this manner, each of films 201a and 158 can be substantially flat, uniformly thick.

When optical alignment is achieved for grin lens 200 and collimator 157, the surface of films 201a and 158 may be approximately perpendicular to the lengths of fibers 155 and a 156 within collimator 157 and to the light paths using the optical configuration shown in FIG. 2. In a preferred embodiment, films 201a and 158 are not perpendicular to the incident and reflected light path, but at an angle of 88.2 degrees for accommodating a spatial separation of 125 microns between the optical fiber 155 and the reflected signal fiber 156, meanwhile reducing the etalon effect induced by having surfaces 201a and 158 parallel. The optical configuration of FIG. 2 may allow up to 99% of the intensity of the optical signal from optical fiber 155 to be transmitted to lens 200. Reflected light may enter reflected signal fiber 156.

As indicated earlier, when the light intensity measured by a detector connected with fiber 227 substantially equals the light intensity that should be received by ferrule 225, then ferrule 225 is optically aligned with collimator 157. Achieving optical alignment for ferrule 225 and collimator 157 means that the output channel is optically aligned with the input optical signal. In preferred embodiments of the present invention, ferrule 225 is laterally shifted by about 62.5 microns from the center line of the lens 200 as the incident light path crosses the lens surface 201a by an angle of 88.2 degrees.

The attachment of lens 200 to support 202 is performed after lens 200 has been optically aligned with collimator 157. Similarly, the attachment of ferrule 225 to support 202 is performed after ferrule 245 has been optically aligned with collimator 157. In other words, lens 200 and ferrule 225 are attached to support 202 so as to maintain optical alignment between the input light beam and the output channel.

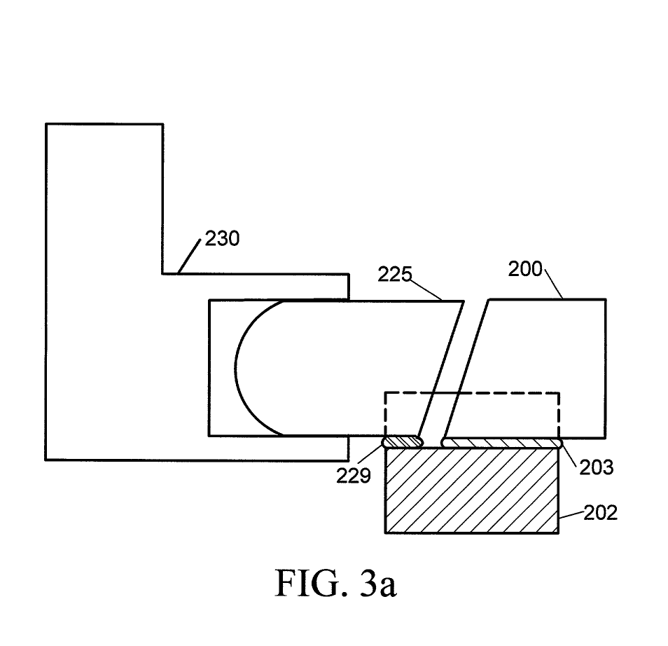

Reference is now made to FIG. 3 wherein there is shown a more detailed diagram of a portion of the embodiment shown in FIG. 2. Specifically, FIG. 3 shows an optional embodiment for bonding ferrule 225 to housing 152. FIG. 3 shows ferrule 225 and support 202. Support 202 is connected with housing 152 (housing 152 not shown in FIG. 3). FIG. 3 shows a view facing ferrule 225; more specifically, the input side of ferrule 225. An attaching material such as epoxy 229 is shown contacting ferrule 225 and support 202. In other words, epoxy 229 attaches ferrule 225 to support 202 so that when epoxy 229 is cured, ferrule 225 has a substantially rigid bond with housing 152 through support 202. It is to be understood that attaching materials other than epoxy may be used for bonding lens 200 to support structure 202; as an example, a solder may be used for bonding lens 200 to support 202.

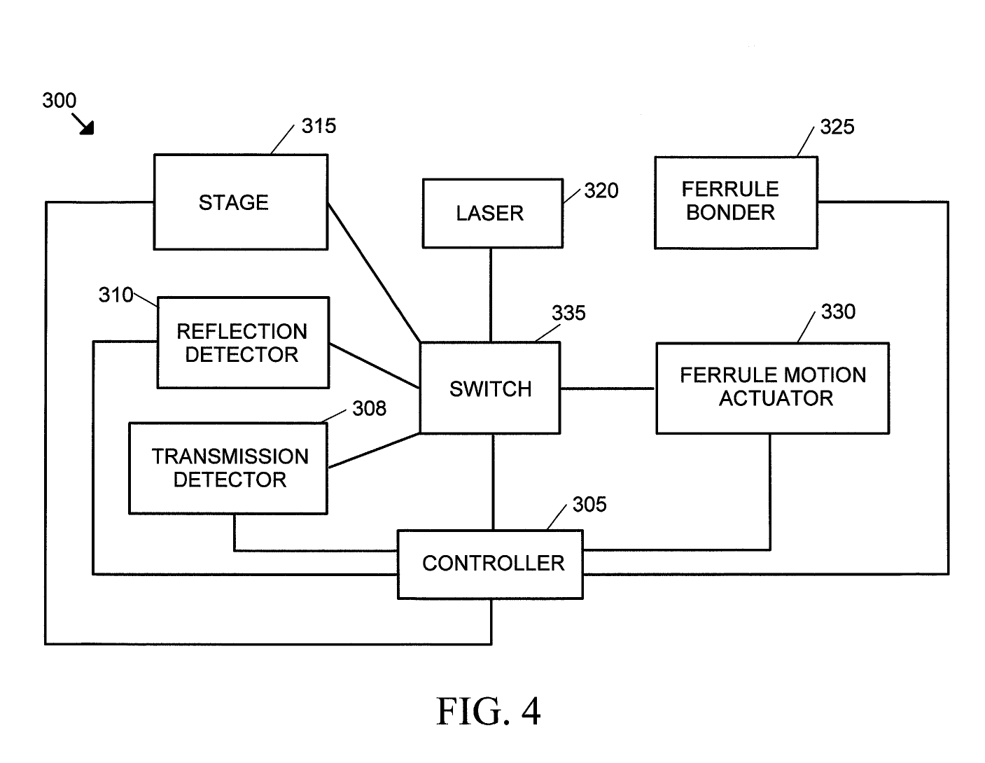

Reference is now made to FIG. 3a wherein there is illustrated a ferrule holder according to one embodiment of the present invention. FIG. 3a shows a side view of lens 200, output channel support 202, attaching material 203, epoxy 209, and ferrule 225, which are all essentially the same as those described for FIGS. 1, 2, and 3. Specifically, FIG. 4 shows a ferrule gripper 230 that grips the back end of ferrule 225. Gripper 230 is configured so that it can be attached to a micro-motion actuator for moving ferrule 225 (actuator not shown in FIG. 3a). Preferably, gripper 230 is a substantially rigid structure having an open section for closely holding ferrule 225 so that ferrule 225 can be accurately positioned in response to movements produced by a micro-motion actuator.

Gripper 230 shown in FIG. 3a has an elbow shape so as to allow easier manipulation of ferrule 230 within the dimensions that may be available in an optical controller such as that shown in FIG. 1. Alternative embodiments of the gripper will be clear to those of ordinary skill in the art, in view of the present disclosure.

Another embodiment of the present invention includes a method of aligning and output channel ferrule in an optical signal controller such as an optical switch. A more specific embodiment includes a method of aligning and output channel ferrule of a rotary motion optical switch having n output channels. The ferrule includes an end of an output fiber and a receiving area for receiving optical signals; the ferrule is disposed proximate to an output channel of the switch. The switch includes a base, an input collimator, preferably a dual fiber input collimator, including an input signal fiber and a reflected signal fiber. The collimator is rotatably connected with the base, and the base includes a surface for attaching the ferrule.

The method includes the step of directing a laser beam toward the receiving area of the ferrule using the input optical fiber and the collimator and measuring the intensity of the light transmitted to the fiber of the ferrule. The intensity of the light directed toward the receiving area of the ferrule is predetermined or can be derived. The method further includes a step of moving the position of the receiving area of the ferrule with respect to the light of the laser beam until the amount of light transmitted to the fiber of the ferrule substantially equals a predetermined amount that corresponds to alignment of the ferrule with respect to the laser beam. Optionally, the method may also include the step of measuring reflected light from the lens reflective surface via the collimator and reflected signal fiber.

As an option, once the position of the ferrule is aligned or otherwise optimized, the value of the transmitted light intensity may be displayed and recorded as a transmitted light level of the channel. In other words, the measured transmitted light intensity may be used as a figure of merit for the performance of the switch for that particular channel. The next step includes bonding the ferrule to the optical signal controller so as to maintain the amount of measured transmitted light. After bonding the ferrule to the support, the method includes the step of releasing the ferrule from the actuator. In a preferred embodiment, the ferrule is held by a gripper through which the actuator acts on the ferrule and the step of releasing the ferrule includes releasing the ferrule from the gripper.

After completing the alignment of the ferrule for the first channel, the method includes the step of rotating at least one of the collimator and the base so as to direct the laser beam toward a second channel and a second ferrule. The second ferrule is aligned using steps analogous to those for the previous ferrule. After aligning the second ferrule, the method includes the step of bonding the second ferrule to the optical switch. The method steps are repeated for each remaining channel and until a ferrule has been aligned and bonded for each channel of the optical switch.

A further embodiment of the method includes the step of producing at least one of motion of the ferrule on an xyz coordinate scale when aligning the ferrule. The motions can be implemented as an iterative process to maximize the transmitted power or other measure of optical alignment. The movement can be performed using a controller such as a computer, microprocessor, and other types of electronic devices. In one embodiment, an error signal is generated based on the measured transmitted power from the ferrule. An example of a suitable error signal would be the expected transmitted power at alignment and the measured transmitted power; in other words, the predetermined power directed toward the ferrule minus the measured transmitted power from the ferrule. The error signal is generated in real time to create a feedback signal for the xyz-coordinate motion adjustments.

A variety of techniques may be used for bonding the ferrule to the switch. Embodiments of the present invention may use methods such as bonding with at least one of ultraviolet light cured epoxy, heat cured epoxy, low-temperature soldering, laser welding, and combinations thereof. A preferred embodiment of the method includes the step of bonding the lens to the switch using ultraviolet light cured epoxy.

In a preferred embodiment of the present invention, the step of moving the ferrule includes using a micro-motion actuator for producing small changes in the position and orientation of the ferrule with respect to the laser beam. Physik Instramente (PI), Suruga Seiki Co., LTD., and Aerotech located in Germany, Japan, and US respectively. More preferably, the step involves using the micro-motion actuator for producing at least one of x-coordinate motion, y-coordinate motion, z-coordinate motion, and combinations thereof of the lens with respect to the laser beam.

Optionally, the method further includes the step of recording the transmitted light measurements as a function of the movement of the ferrule so as to derive sensitivity curves relating transmitted light signals and movement of the ferrule. In preferred embodiments, the transmitted light measurements are recorded as a function of x-coordinate motion, y-coordinate motion, and z-coordinate motion of the ferrule during the alignment. These plots of the experimental data can serve as Ferrule Alignment Sensitivity Plots (experimental curves) that can be used as part of the alignment process. Optionally, the method includes storing the measurements electronically. Alternatively, the measurements may be printed out in a hardcopy format.

After completion of the alignment of each of the ferrules, the method includes further optional steps of testing and documenting the performance of the optical switch. The method may further include the step of performing a scan of all of the channels in the switch and measuring the transmitted optical signal for each of the aligned ferrules. Preferably, the scan is done with very high arc resolution relating transmitted power and reflected power with the position of the collimator. The data of the scan is automatically collected, tabulated, and stored electronically such as on a hard disk, floppy disk, or other electronic information storage media.

The method may further include the step of plotting transmitted power measurements and power directed toward the ferrule as functions of position information for the input collimator. In some embodiments, the method optionally includes the steps of calculating the channel-to-channel spacing using the recorded data; also, each channel's maximum reflective power may be derived using the data.

A preferred embodiment includes the optional step of making all of the data available to the computer program containing the main code for aligning the ferrule. All of the position and power measurement data may be loaded into a code file for each particular switch and is made available so that it can be downloaded to an electronic control board of the switch. In other words, some embodiments of the switch are capable of storing a computer program; the code file for each switch can be stored in the memory resources of the switch.

A further embodiment of the present invention may include the optional step of generating barcode indicia such as on a physical bar code label and associating the barcode indicia with a code file for a switch so that the code file can be identified using the barcode indicia. The barcode indicia, preferably is applied to the housing of the switch so that the barcode indicia is easily available. This can be accomplished by simply applying a barcode label having the indicia adhesively to the housing of the switch.

Optionally, the method may include further steps of testing the switch. For example, the method may include the step of loading the code to the internal controller for the switch and allowing the internal controller to perform the switching functions while recording the reflected light signals and transmitted light signals as functions of the collimator position. The data recorded with the switch under internal control is compared to the data recorded previously. If the internal control data substantially corresponds to that of the previous data, in other words, meets the specifications, then the switch is sent to the next fabrication step. If the specifications are not met, then the process is repeated starting with the step of scanning all of the channels under the control of the alignment station. Another optional step of the method includes providing a hard copy of the data file of position versus power transmission curves and sending the hardcopy along with the switch to the next fabrication station.

In a preferred embodiment of the method, the step of moving the ferrule to achieve alignment is carried out with the ferrule contacting an unset or uncured attaching material that is also contacting a support surface of the switch. An advantage of the step is that the ferrule can be bonded using the attaching material by curing or allowing the attaching material to set without having to apply the attaching material at that the alignment position for the ferrule has been found. Consequently, there is reduced opportunity for disturbing the alignment that can occur if the attaching material is applied after the alignment is obtained. An example of suitable materials for the attaching material includes uncured epoxy compounds such as ultraviolet light cured epoxy and heat-cured epoxy. For specific embodiments, an amount of uncured epoxy is applied to the ferrule-contacting surface of the switch followed by contacting the ferrule to the epoxy.

In a preferred embodiment of the present invention, the alignment method includes aligning a ferrule with a lens disposed in front of the ferrule. The lens has been previously aligned with respect to the incoming collimator beam from input collimator. During the alignment of the ferrule, the position of the input collimator is offset from the maximum light transmission as determined by the reflective power measurements feedback control signal. The position of the input collimator is off set from maximum light reflection by an amount so as to linearize the response of the reflective power. This off set can be automatically determined and digitized using software. The output ferrule transmission is aligned with respect to this beam offset at the back of the lens.

Embodiments of the present invention include a Ferrule Assembly Station that can automatically align ferrules to an input collimator of an optical signal controller so as to achieve a desired or maximum optical transmission coupling. The assembly operation includes aligning a ferrule coupled to an output fiber and having a receiving area with respect to an incoming collimator beam from the input collimator to maximize light transmitted to the output fiber of the. In the alignment station, the dual-fiber collimator is used to project light into the lens being aligned. The position of the lens is adjusted using xyz coordinate movements relative to the incoming beam until the transmitted light is focused and the transmitted light intensity substantially matches a predetermined light intensity that is expected when alignment is achieved. Preferably, the input collimator comprises a dual-fiber ferrule that is capable of directing the input light beam as well as receiving a reflected light signal.

Reference is now made to FIG. 4 wherein there is shown a schematic diagram of a ferrule alignment station 300 according to one embodiment of the present invention. The station includes a station controller 305 such as, for examples, a computer, a microprocessor, and an application specific integrated circuit. Preferably, controller 305 is a main computer capable of sending and receiving information. In one configuration, the computer transfers information using a bus such as a general-purpose interface bus. Station 300 also includes a light intensity measuring device such as transmission detector 308, a second light intensity measuring device such as reflection detector 310, a stage 315, an optical signal source such as a laser 320, a ferrule bonder 325, and a ferrule motion actuator 330. Controller 305 is connected with detector 308, detector 310, stage 315, ferrule bonder 325, and ferrule motion actuator 330 so that information and/or control commands can be transferred between controller 305 and the connected items. Optionally, the controller may also be connected with laser 320 so that information and/or commands can be transferred between controller 305 and laser 320.

FIG. 4 also shows how a switch such as a rotary switch 335 would be arranged when being processed by station 300. More specifically, FIG. 5 shows how switch 335 would be connected with the elements of station 300 while station 300 is performing an alignment on switch 335. For this example, switch 335 is substantially the same as that described for the switch in FIG. 1.

As indicated in FIG. 5, optical switch 335 is electronically coupled to controller 305 so that controller 305 and optical switch 335 can interchange commands and information. In some embodiments, controller 305 is connected to switch to 335 to allow controller 305 to control the movement of the voice coil motor in switch 335. Optionally, switch 335 and controller 305 may be connected so as to allow data collected by controller 305 to be downloaded to switch 335 and stored in memory resources that may be available in switch 335.

Transmission detector 308 is capable of measuring the intensity of a transmitted laser beam. Particularly, detector 308 is for measuring the transmitted optical signal from the output fiber of the ferrule that is being aligned in station 300. There are numerous commercially available detectors that are suitable for use as detector 308. Detector 308 is capable of transmitting reflected signal measurement data to controller 305. During the alignment process transmission detector 308 is connected with switch 335 so as to measure the transmitted optical signal used for aligning the ferrule.

Reflection detector 310 is capable of measuring the intensity of a reflected laser beam. Particularly, particularly detector 310 is for measuring the reflected optical signal from the semi reflective surface of a lens placed in front of the ferrule that is being aligned in station 300. There are numerous commercially available detectors that are suitable for use as detector 310. The detector 310 is capable of transmitting reflected signal measurement data to controller 305. During the alignment process, reflection detector 310 is connected with switch 335 so as to measure the reflected optical signals from the lens.

Stage 315 is preferably a rotary stage for supporting and holding switch 335 during the ferrule alignment. In preferred embodiments, stage 315 is capable of clamping a switch such as switch 335 in place so that rotary motion produced by the stage causes rotation of the switch. Preferably, the rotation caused by stage 315 is coaxial with the rotation of the input collimator of the switch. The stage 315 also includes a holder for substantially locking the movement of the input collimator of the switch so that the collimator points in a predetermined direction. In one embodiment to holder comprises a substantially rigid structure connected with the stage that makes contact with the collimator so as to prevent motion of the collimator. It is to be understood that this is but one embodiment of the present invention; a person of ordinary skill in the art will understand that other methods can be used for locking the position of the collimator during the alignment. For example, the collimator position may be locked in place, in part, through use of the voice coil motor used for controlling the motion of the collimator. Still further, power may be applied to the voice coil motor so that the voice coil motor actively pushes against the holder to so as to lock the collimator in place.

Stage 315 is arranged so that it can receive commands and perform control commands from controller 305. In some embodiments, stage 315 includes one or more motorized drives controlled by controller 305. Examples of commands from controller 305 include commands to cause stage 315 to rotate switch 335 so that a subsequent channel can be positioned for ferrule alignment.

A variety of lasers are commercially available that can be used for laser 320. Suitable lasers are commonly used for optical signal transmission testing. In preferred embodiment, laser 320 is capable of the connected with controller 305 so that laser 320 can transfer information to controller 305. As a further option, laser 320 may be arranged so that controller 305 can cause laser 320 to perform actions such as turn on, turn off, initialized, and follow other commands. During the alignment, a laser beam output from laser 320 is connected with switch 335 so as to provide the input laser beam as described earlier.

Ferrule bonder 325 may be selected from a variety of technologies for bonding a ferrule to an optical switch. For example, lens bonder 325 may include an ultraviolet light source used for curing ultraviolet light sensitive epoxy. In this case, the ultraviolet light source would be directed to impinge upon the epoxy used for attaching the ferrule to the switch. Alternatively, ferrule bonder 325 may include a heat source used for curing thermal setting epoxy. As another alternative, ferrule bonder 325 may include a laser for laser welding the lens to the switch. As still another alternative, bonder 325 may include lens mechanism for soldering the lens to the switch. Bonder 325 is disposed with respect to the switch so as to allow the bonding step to be performed. Bonder 325 is connected with controller 305 so that the controller can initiate and terminate the bonding step as needed when the aligned position of the ferrule has been found.

Ferrule motion actuator 330 is connected with a ferrule during the alignment of the ferrule. The actuator 330 is capable of holding the ferrule proximate to channel of the switch for which the ferrule is being aligned. For some embodiments of the present invention, this may include holding the ferrule in contact with an uncured attaching compound on the switch. Preferably, actuator 330 includes a miniaturized mechanical mechanism for holding the ferrule in front of the input beam and produces xyz coordinate system movement of the ferrule to optimize the measured transmitted light intensity. The mechanism for the ferrule may comprise a ferrule gripper (gripper not shown in FIG. 4) such as the gripper described in FIG. 3a through which the actuator acts on the ferrule.

Preferably, the mechanism holds the ferrule proximate to the location for bonding such as at a lens support or an output post slot for the channel. The mechanism has micro-maneuvering capabilities in the xyz coordinate directions. This mechanism is capable of holding the ferrule when the ferrule is sitting in the output post slot. The actuator 330 has micro-maneuvering capabilities in the X, Y, and Z directions. The motions produced by actuator 330 are controlled by three linear translation mechanical mechanisms or piezo-electric crystals. The three-translation motion allows the production of highly precise and repeatable linear translation adjustment motions. The actuator 330 operates under the command of controller 305. The magnitude and the direction of X, Y, and Z motion is decided by the feedback signal generated from light transmission coupling error signal derived from the data received from detector 308.

In preferred embodiments, actuator 330 is connected with controller 305 so that controller 305 can provide feedback control commands for adjusting the movement of the ferrule in response to an error signal produced using measurements from detector 308 of the transmitted light signal. Upon detection of alignment based on the error signal, controller 305 stops the motion of actuator 330 and initiates the ferrule bonding by sending a command to bonder 325.

As an option for some embodiments of the present invention, station 300 also includes a bar code printer (not shown in FIG. 5) connected with controller 305. The bar-code printer may be used for printing labels with bar-code indicia for identifying measurement data were each aligned switch.

In an alternative embodiment of the present invention, stage 315 may be replaced with a fixed stage and a radial arc positioning mechanism, such as a MicroE PA155 encoded actuator made by MicroE Systems, Inc., Natick, Mass. The MicroE PA155 is arranged upside down with the center of the shaft aligned with the center of the arm of the switch as a part of station 300. A driving arm with orthogonal pin may be attached to the MicroE rotary shaft to hold switch collimator and to move the collimator radially in front of the output channels. The radial arc mechanism can be fully configured by using a motion control board interfaced with controller 305 so that substantially all theoretical radial center positions of each channel of the output post are available. The radial arc mechanism is capable of going to the center of any channel and performing a high resolution seek to optimize the power transmission of the channel; this mechanism can be used to work in conjunction with actuator 330 to optimize the transmitted power signal.

Optionally, station 300 may also include a base (not shown in FIG. 4) for supporting stage 315 and actuator 330. The base may also be used to support ferrule bonder 325. Preferably, the base provides a substantially stable surface with reduced vibration susceptibility. A suitable base may include a high-density material such as a mass of granite; granite is also advantageous because it has superior dimensional stability properties.

In addition, embodiments of station 300 may also include a table or a frame for holding the components of the station. In a still further embodiment of the present invention, station 300 may also include wheels or casters for rolling the station when the station needs to be moved.

Another embodiment of the present invention includes computer executable instructions for performing the alignment of ferrules in an optical signal controller. These instructions may reside in a computer, a microprocessor, an application-specific integrated circuit, or computer readable media such as compact disks, and floppy disks.

Embodiments of the present invention may include computer executable instructions for performing the steps of:

a) placing a ferrule proximate to a first output channel position of an optical signal controller;

b) controlling the movement of the ferrule with respect to a laser beam directed toward the ferrule so as to achieve a measured amount of transmitted light from the ferrule that substantially equals to a predetermined amount of light;

c) activating a bonding process so as to bond the ferrule to the signal controller when the measured amount of transmitted light about equals the predetermined amount of light;

d) repeating steps a through c for each channel of the optical signal controller.

Embodiments of the present invention may further include instructions for recording measurements of the amount of light transmitted by the optical ferrule as a function of the movement of the ferrule during the alignment process. Optionally, embodiments of the present invention may include the step of recording the reflected light intensity as a function of input collimator position. A preferred embodiment of the present invention also includes instructions for at least one of rotating the direction of the laser beam and rotating the optical signal controller.

Preferably, data collection, data storage, motion control of the optical switch, alignment optimization algorithm, user interface, function display, and data display can be arranged under the control of controller 305. The control theory for the alignment algorithm can be written in C++ and executed in interpreted fashion for fast execution in a real time working environment of the switch. It is to be understood that the algorithm can be written, as an option, in other computer programming languages such as C, BASIC, assembly language, and others.

Design for manufacturability is, essentially, inherent for embodiments of the present invention. Aspects of the present invention are usable in a rotary motion switch such as that described for FIG. 1 and such as the radial/rotary switch described in U.S. patent application No. 60/256,059, filed on Dec. 15, 2000.

One of the benefits of embodiments of the present invention is that each channel of the optical signal controller is aligned using the same alignment algorithm, the same gripping mechanism, and the same software and computer code. This means that each channel can be aligned within about the same alignment time. Reproducibility is maximized; the same alignment station can be used to align similar optical signal controllers.

It is to be understood that the embodiment of the present invention shown in FIG. 1 is but one configuration. In alternative configurations, optical components other than optical fibers may be included or may replace the optical fibers described for the embodiment shown in FIG. 1. Some examples of the types of optical components are optical fibers, prisms, mirrors, electronic detectors such to as photo-detectors, and lasers.

Embodiments on the present invention can be used to accelerate fabrication of optical signal controllers that include optically aligned output ferrule. An example of an estimated time budget for aligning output ferrules in an optical signal controller according to one embodiment of the present invention will now be provided. The estimate is for an 8-channel optical signal controller such as a 1×8 channel optical switch having one input collimator and 8 output channels.

1. Loading switch into alignment station and optical and electrical hook up (2 min)

2. Boot up the system and download the software (1×8 etc. alignment software) (2 min).

3. Start alignment computer program (1 min).

4. System reference check and initialization of alignment station components and mechanisms (2 min).

5. Align ferrule for channel one and can bond ferrule to switch with UV light curable epoxy and application of UV light (max 3 min).

6. Move to each of the remaining channels, aligning the lens and bonding the lens to the switch at each channel (max: 7×3 min=21 min).

7. Data collection and curve plotting and data storage and data analysis (parallel processing) (0 min).

8. Final scan of all the channels (1×8) 12 seconds per channel (2 min).

9. Bar code read, data transfer to code computer and download of firmware code to switch (1 min).

10. Voice coil motor sweep of the channels (2 min).

11. Update code (1 min).

12. Unload switch from alignment station and hardcopy data printing (5 min).

The total approximate time is around 40 min per 1×8 switch with a fully automated station this corresponds to a maximum of about 5 min/channel. It is to be understood that the time estimates for the present example are hypothetical. The actual times for other embodiments of the present invention may be higher or lower than the estimated times of the present example.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a nonexclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A method of aligning a ferrule of an optical signal controller, the method comprising the steps of:
a) directing a collimated light beam toward the receiving area of the ferrule;
b) measuring the amount of the light transmitted to an output fiber coupled to the ferrule;
c) moving the position of the receiving area of the ferrule with respect to the light beam until the amount of light of the light transmitted to the output fiber substantially equals a predetermined amount;
d) bonding the ferrule to the optical signal controller so as to maintain the amount of measured transmitted light.

2. The method of claim 1 wherein the optical signal controller comprises an optical switch.

3. The method of claim 2 wherein the optical switch includes n output channels with n being an integer.

4. The method of claim 3 further comprising repeating steps a through d for each channel.

5. The method of claim 1 wherein the optical signal controller comprises at least one of an optical switch, a variable optical attenuator, and opto-electronic switch, a power monitor, a fiber collimator, an optical isolator, and an optical circulator.

6. The method of claim 1 wherein the optical signal controller uses rotary motion of an optical component for optical signal control.

7. An optical signal controller having at least one output ferrule and an optical component for directing an optical signal toward the ferrule, the optical component and the ferrule being optically aligned using the method of claim 1.

8. A method of aligning an output channel ferrule of a rotary motion optical switch having n output channels, the ferrule having a receiving area and an output fiber couple thereto, the switch having a base, a dual fiber input collimator including an input signal fiber and a reflected signal fiber, the collimator being rotatably connected with the base, the base having a surface for attaching the ferrule, the method comprising the steps of:
a) directing a laser beam toward the receiving area of the ferrule using the input optical fiber and the collimator, the ferrule being disposed proximate to an output channel of the switch;
b) measuring the intensity of light transmitted to the output fiber from the collimator and the input optical fiber;
c) moving the position of the receiving area of the ferrule with respect to the laser beam until the amount of light transmitted to the output fiber substantially equals a predetermined amount;
d) bonding the ferrule to the optical signal controller so as to maintain the amount of measured transmitted light.

9. The method of claim 8 wherein the switch comprises a plurality of channels and further comprising the steps of:
rotating at least one of the collimator and the base so as to direct the laser beam toward a second channel and a second ferrule; and
repeating steps b through d for the second channel and the second ferrule.

10. The method of claim 8 wherein the switch comprises a plurality of channels and further comprising the steps of:
e) rotating at least one of the collimator and the base so as to direct the laser beam toward another channel and another ferrule; and
f) repeating steps b through d for the second channel and the another ferrule.

11. The method of claim 10 further comprising the step of repeating steps e and f until a ferrule is bonded to each channel of the switch.

12. The method of claim 8 wherein step c comprises at least one of x coordinate motion, y coordinate motion, z coordinate motion, and combinations thereof.

13. The method of claim 8 wherein step d comprises bonding using at least one of ultraviolet light cured epoxy, heat cured epoxy, low-temperature soldering, laser welding, and combinations thereof.

14. The method of claim 8 wherein step d comprises bonding using ultraviolet light curable epoxy.

15. The method of claim 8 wherein step c comprises using a micro-motion actuator for producing small changes in the position of the lens with respect to the laser beam.

16. The method of claim 8 wherein step c comprises at least one of x coordinate motion, y coordinate motion, z coordinate motion, and combinations thereof.

17. The method of claim 8 further comprising the step of recording the transmitted light measurements as a function of the movement of the ferrule.

18. The method of claim 8 further comprising providing an amount of un-cured epoxy contacting the ferrule and a surface for attaching the ferrule.

19. The method of claim 18 wherein the uncured epoxy is present during step c.

20. An optical signal controller having at least one output channel optical ferrule and an optical component for directing an optical signal toward the ferrule, the optical component and the ferrule being optically aligned using the method of claim 8.

21. The optical signal controller of claim 20 further comprising a bar code wherein the bar code indicia corresponds to a set of measurements of transmitted signal and position of the collimator.

22. A station for aligning a ferrule for an optical signal controller, the station comprising:
a laser light source capable of providing an optical signal to the signal controller;
a detector for measuring transmitted light intensity at the output of the ferrule;
a ferrule motion actuator, the actuator being capable of holding the ferrule, the actuator being capable of moving the ferrule so as to change the position of the ferrule;
a stage for holding the optical signal controller, the stage being capable of rotating the signal controller;
a ferrule bonder for bonding the ferrule to the signal controller;
a station controller, the station controller being connected with the detector to receive data measured by the detector, the controller being connected with the motion actuator so as to be capable of moving the ferrule in response to measurements from the detector, the station controller being connected with the bonder so as to be capable of initiating and terminating bonding of the ferrule to the signal controller as needed, the station controller being connected with the stage so as to be capable of controlling the rotary motion of the stage.

23. The station of claim 22 wherein the station controller is capable of controlling the movement of the ferrule so as to substantially obtain a predetermined transmitted signal measurement.

24. The station of claim 22 further comprising a second detector for measuring reflected light intensity.

25. The station of claim 23 wherein the station controller comprises a feedback control loop for controlling the movement of the ferrule in response to the measured transmitted light intensity.

26. The station of claim 22 wherein the bonder comprises at least one of an ultraviolet light source for curing epoxy, a heat source for curing epoxy, a laser for laser welding, and a heat source for heating solder.

27. The station of claim 22 wherein the bonder comprises an ultraviolet light source for curing epoxy.

28. The station of claim 23 wherein the station controller is capable of storing the measurements of the amount of light transmitted as a function of the movement of the ferrule.

29. An optical signal controller having at least one ferrule aligned using the station of claim 22.

30. Computer readable media comprising executable instructions for performing the steps of:
a) placing a ferrule proximate to a first output channel position of an optical signal controller;
b) controlling the movement of the ferrule with respect to a laser beam directed toward the ferrule so as to achieve a measured amount of transmitted light from the ferrule that substantially equals to a predetermined amount of light;
c) activating a bonding process so as to bond the ferrule to the signal controller when the measured amount of transmitted light substantially equals the predetermined amount of light;
d) repeating steps a through c for each channel of the optical signal controller.

31. The invention of claim 30 further comprising instructions for recording measurements of the amount of light transmitted by the ferrule as a function of the movement of the ferrule.

32. The invention of claim 30 wherein step d comprises instructions for at least one of rotating the direction of the laser beam and rotating the optical signal controller.

33. The station of claim 22 wherein the actuator comprises a ferrule gripper for holding the ferrule.
